(19) United States
(12) Patent Application Publication
(10) Pub. No.: US 2014/0378196 A1
(43) Pub. Date: Dec. 25, 2014

(54) REPLACEMENT SYMBOL SKILL-BASED REDEMPTION GAME

(71) Applicant: EPIC SYSTEMS, LLC, Piedmont, SC (US)

(72) Inventors: Timothy Oliver Caldwell, Piedmont, SC (US); Steven Wesley Davis, Suwanee, GA (US); William Criss Martin, Melissa, TX (US)

(73) Assignee: EPIC SYSTEMS, LLC, Piedmont, SC (US)

(21) Appl. No.: 14/195,936

(22) Filed: Mar. 4, 2014

Related U.S. Application Data
(60) Provisional application No. 61/839,107, filed on Jun. 25, 2013.

(51) Int. Cl. G07F 17/32

(52) U.S. Cl. CPC G07F 17/3295
USPC 463/7

(57) ABSTRACT

Embodiments generally relate to methods and systems for providing a skill-based redemption game. An indication of a user desire to participate in the skill-based redemption game is received. The user's account balance is decreased, and simulated reels are spun. A plurality of symbols is displayed in an area separate from the simulated reels. The user must select a symbol in the plurality to replace with a replacement symbol. If the user's replacement creates a winning pattern, the user is rewarded with an increased account balance. The user may also be provided a bonus amount for achieving a number of consecutive wins.

### FIELD

Embodiments disclosed herein generally relate to software systems for skill-based redemption games.

### BACKGROUND

Skill-based redemption games are typically games that require some level of skill in order to win. A winner of such a skill-based redemption game may be rewarded with points, credits, or other such designation. Accumulated points or credits may be exchanged for non-cash merchandise, such as small toys, novelties, gift cards, or other merchandise or service, depending on the jurisdiction in which the skill-based redemption game is located.

### BRIEF DESCRIPTION OF THE DRAWINGS

Reference will now be made to the accompanying figures and diagrams, which are not necessarily drawn to scale, and wherein:

FIG. 1 shows a block diagram of a system for providing a skill-based redemption game, according to one or more example embodiments.

FIG. 2 shows an example of a skill-based redemption game, according to one or more example embodiments.

FIG. 3 shows a further example of a skill-based redemption game, according to one or more example embodiments.

FIG. 4 shows a further example of a skill-based redemption game, according to one or more example embodiments.

FIG. 5 shows a further example of a skill-based redemption game, according to one or more example embodiments.

FIG. 6 shows a flow diagram for a skill-based redemption game, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “server” may refer to any computing device having a networked connectivity and configured to provide one or more dedicated services to clients, such as a mobile device. The services may include storage of data or any kind of data processing. One example of the server may include a web server hosting one or more web pages. Some examples of web pages may include social networking web pages. Another example of a server may be a cloud server that hosts web services for one or more computer devices.

Embodiments disclosed herein relate to a providing a skill-based redemption game. In some embodiments, the skill-based redemption game is a matching game. Such a skill-based redemption game may be designed to display one or more simulated reels, each of which has a plurality of symbols displayed thereon. A spin of the simulated reels occurs when the player chooses to play the skill-based redemption game. The symbols on the simulated reels may or may not have any connection to the skill-based redemption game. To win the skill-based redemption game, the player must create a winning pattern by choosing a correct candidate symbol to be replaced by a replacement symbol.

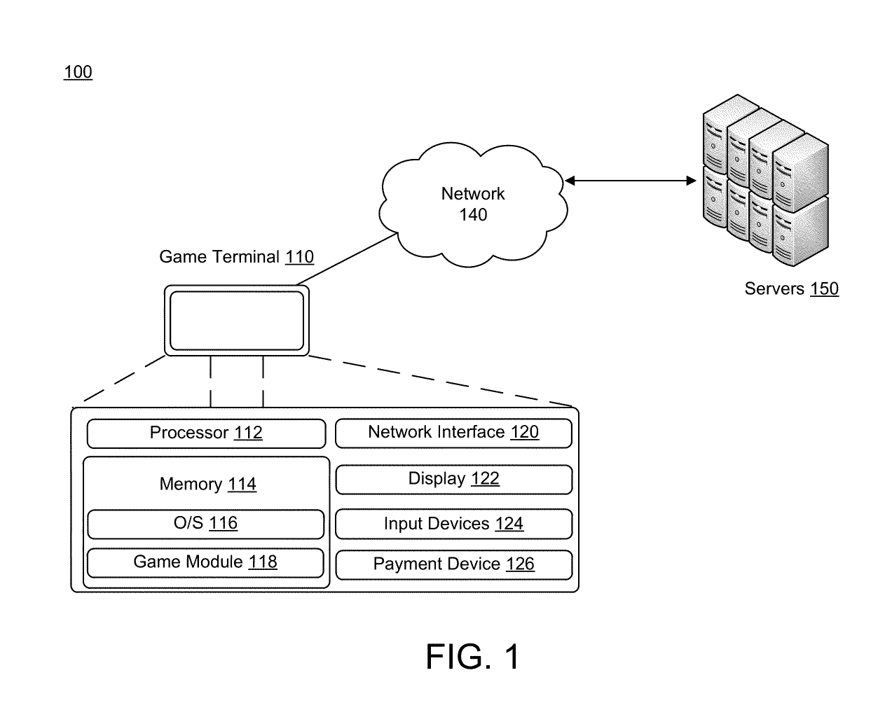

FIG. 1 depicts a system 100 for providing such a skill-based redemption game. The system 100 may include a game terminal 110 having one or more processors 112, a memory 114 storing an operating system 116 and game module 118, a network interface 120, a display 122, an input device 124, and a payment device 126, all of which may be in communication with each other. In one embodiment, the game terminal 110 may be a desktop computer, laptop computer, or tablet computer.

The computer processors 112 may comprise one or more cores and may be configured to access and execute (at least in part) computer-readable instructions stored in the memory 114. The one or more computer processors 112 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The game terminal 110 may also include a chipset (not shown) for controlling communications between the one or more processors 112 and one or more of the other components of the game terminal 110. The one or more processors 112 may also include one or more application-specific integrated circuits (ASICs) or application-specific standard products (ASSPs) for handling specific data processing functions or tasks.

The memory 114 may comprise one or more computer-readable storage media (CRSM). In some embodiments, the memory 114 may include non-transitory media such as random access memory (RAM), flash RAM, magnetic media, optical media (e.g. CD-ROM, DVD-ROM, BD-ROM), read-only memory (“ROM”), erasable programmable ROM (“EPROM”), electrically EPROM (“EEPROM”), solid-state media, and so forth. The memory 114 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 114 may store an operating system 116 that includes a plurality of computer-executable instructions that may be implemented by the computer processor 112 to perform a variety of tasks to operate the interface(s) and any other hardware installed on the game terminal 110. The memory 114 may also store content that may be displayed by the game terminal 110 or transferred to other devices (e.g., headphones) to be displayed or played by the other devices. The memory 114 may also store content received from the other devices. The content from the other devices may be displayed, played, or used by the game terminal 110 to perform any necessary tasks or operations that may be implemented by the computer processor 112 or other components in the game terminal 110.

The memory 114 may also store a game module 118 that includes a plurality of computer-executable instructions that may be executed by the computer processor 112 to perform a variety of tasks, as will be further explained below.

The network interface 120 may also comprise one or more communication interfaces or network interface devices to provide for the transfer of data between the game terminal 110 and another device (e.g., network server) via a network, such as network 140. The communication interfaces may include, but are not limited to: personal area networks (PANs), wired local area networks (LANs), wireless local area networks (WLANs), wireless wide area networks (WWANs), and so forth. The game terminal 110 may be coupled to the network via a wired or wireless connection.

The display 122 may include, but is not limited to, a liquid crystal display, a light-emitting diode display, or a cathode-ray tube display. Other such displays are possible as well. The display may be used to show content to a user in the form of text, images, or video. In certain instances, the display may also operate as a touch screen display that may enable the user to initiate commands or operations by touching the screen using certain finger or hand gestures.

The game terminal 110 also includes one or more input devices 124. As described above, an input device 124 may include a touch screen input device coupled with or combined with display 122 that enables the user to initiate commands by touching the screen. Input devices 124 may also include a keyboard, numeric pad, mouse, trackball, one or more electromechanical buttons, a camera which detects gestures, or another input device.

The game terminal 110 may also include one or more payment devices 126. Payment device 126 may include a card reader to read payment and/or account information from a debit or credit card, including magnetic readers as well as wireless (e.g. radio frequency or near field communication) readers. Payment device 126 may also include a card reader to read a customer loyalty or other identification card. The payment device 126 may also include a cash acceptor for receiving paper and/or coin currency. Payment device 126 may also include a receipt printer and dispenser to provide a user or player with a receipt. In one embodiment, the payment device 126 may provide the user with a receipt containing a code, such as a 16-digit hexadecimal code, that a user or player can use to access an account on a separate device, computer, or game terminal 110. In one embodiment, the user may be required to input biographical or identifying information, such as a name, phone number, username, password, date of birth, e-mail address, or other information, when playing a game on game terminal 110. Such information may also be stored in memory 114, or communicated to a server 150.

In one embodiment, game terminal 110 may include a cabinet that houses display 122 for displaying a game, along with other components. The cabinet housing may include a series of electromechanical buttons positioned on the cabinet for use as a user interface or input device 124 for controlling game play features such as commencing play, terminating play, etc.

System 100 may also include one or more servers 150. Servers 150 may store information used by game terminal 110, such as but not limited to game module software, player data, or other such information. One or more game terminals 110 may periodically download or otherwise retrieve an updated game module 118 from a server 150. In one embodiment, game terminals 110 may transmit reporting data, such as a number of games played or an amount paid out, to a server 150. Game terminals 110 may also transmit diagnostic data to a server 150. The game terminal 110 and the server(s) 150 may be in communication with each other through one or more networks 140.

As noted above, game terminal 110 includes game module 118, which may include instructions executed by processor 112 that cause game terminal 110 to provide a skill-based redemption game to a user or game player. The terms “user” and “player” are used interchangeably herein. The skill-based redemption game may display one or a plurality of simulated reels to the player. Each simulated reel includes a plurality of symbols, such as a club, pair of cherries, bell, or other such symbols. In one embodiment, the skill-based redemption game may display five simulated reels to the player. The game module 118 may also store one or more winning combinations of symbols and prize information corresponding to the winning combinations, as will further be described below. In one embodiment, game module 118 may be downloaded from server 150, and data associated with game module 118 may be stored on server 150 or on a collection of servers 150.

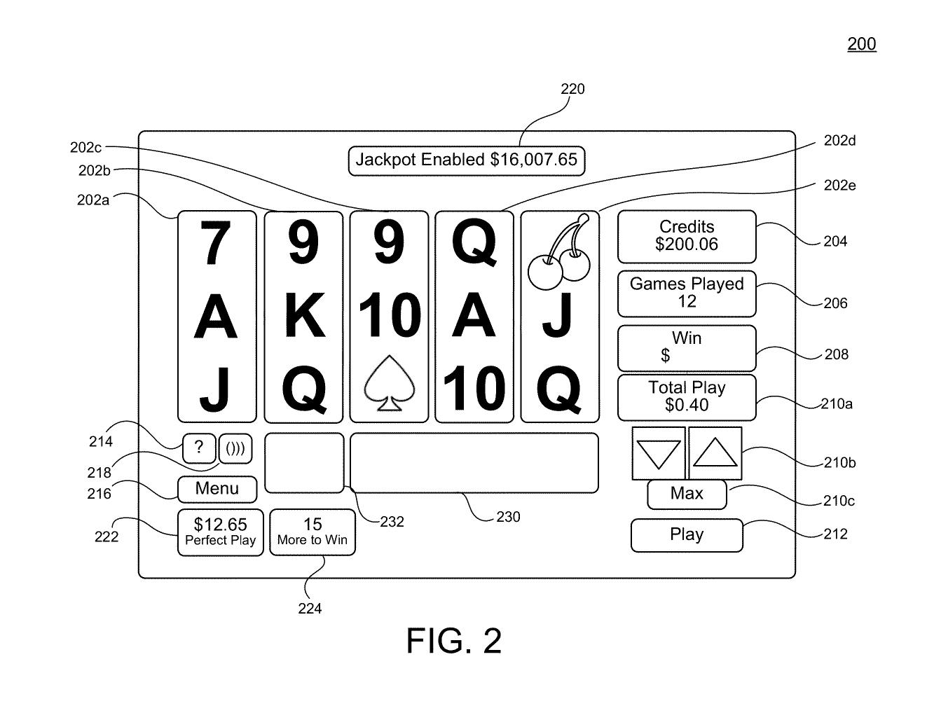

FIG. 2 is an example of a skill-based redemption game 200 provided to a player. Skill-based redemption game 200 may be provided by game module 118 of game terminal 110. The example of FIG. 2 may illustrate a starting point for the skill-based redemption game 200. As seen in FIG. 2, the game 200 may display simulated reels 202a-e, along with an amount of money the player has contributed for game play 204 (e.g., available credits). The amount of money may be shown as credits, points, money, or other similar designation.

The game 200 may also display a number of games the player has played 206. Certain jurisdictions have limits on the value of prizes or rewards awarded by skill games. For example, one jurisdiction limits prizes to merchandise which has a wholesale value of $5.00 or less per single play of a game. Thus, the number of games the player has played 206 (also known as “hand count”) may be used to track the number of games played to ensure that the player is not awarded more than $5.00 per game played.

The game 200 may also display a “Win” amount 208, which may display the amount of money the player has won after a successful game. The game 200 may also display an amount of credits used to play the particular game 210a. Such an amount may be designated, in one embodiment, as “Total Play” or a similar designation. In one embodiment, the game 200 may also display up and down arrows 210b, which may enable a player to adjust the amount of money or credits played for a particular game, as well as a “MAX” button 210c to allow the player to use the maximum amount of credits permitted (by law or as desired by a provider of game 200) for a particular game. Further, the game 200 may display a “Play” button 212 which initiates the start of a new game.

In one embodiment, the game 200 also displays a help button 214, a menu button 216, and a volume adjustment button 218. Help button 214 may provide the player with instructions on how to play the skill-based redemption game, prizes available, and other relevant information. Menu button 216 may enable the player to adjust certain settings of the game 200. Volume adjustment button 218 may enable the player to increase or decrease simulated sounds of the game 200.

Game 200 may also display a jackpot amount 220. Further, game 200 also may display a bonus amount 222 and bonus counter 224. In one embodiment, bonus amount 222 is increased when a player has an unsuccessful game. Further, bonus counter 224 may be decremented when a player has a successful game. If the player has a certain number of consecutive successful games (e.g., 10, 15, or any other number), the player may be rewarded with the bonus amount 222. Additionally, the bonus counter 224 may be reset each time the player has an unsuccessful game. Finally, game 200 also may display a candidate symbol area 230 and a replacement symbol area 232. Candidate symbol area 230 contains an area for three candidate symbols, while replacement symbol area 232 contains an area for one replacement symbol or “winning symbol.” These symbol areas are further described below with reference to game play.

After a player deposits coins, bills, tickets, or after a player swipes a card or otherwise pays to play the game 200, the player begins a game by pressing the “Play” button 212 (or other similar button or icon). Upon pressing the button 212, the simulated reels 202a-202e begin spinning (optionally, independently of one another), and stop after a certain amount of time or a certain number of rotations. In one embodiment, the game 200 may cause one simulated reel 202 to spin faster, slower, longer, or shorter than another simulated reel 202. Each simulated reel 202 may stop simultaneously or at varying times. In one embodiment, the game 200 may display a “stop” button that enables the player to control when the simulated reels 202 stop spinning, either individually or collectively. Additionally, upon pressing the “Play” button 212, the player's available credits may be reduced by the amount of credits used for that game.

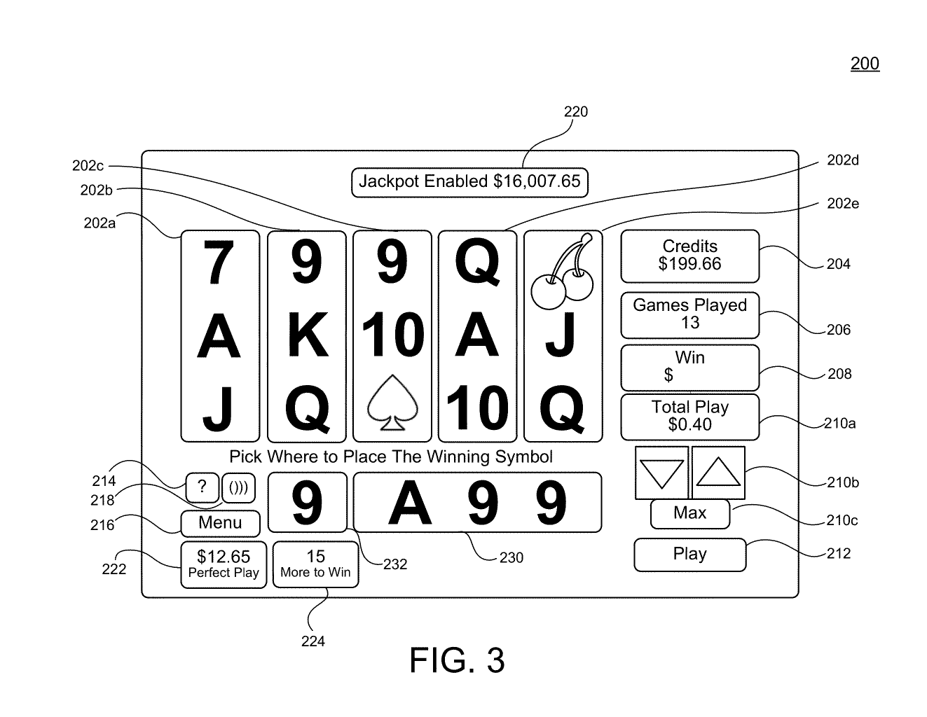

FIG. 3 is an example of skill-based redemption game 200 after the simulated reels 202 have stopped spinning At this point in the game, the player must participate to win the skill-based redemption game. As seen in FIG. 3, game module 118 may place three candidate symbols in candidate symbol area 230. In the example of FIG. 3, the candidate symbols are two “9” symbols and one “A” symbol. Additionally, game module 118 may place one replacement symbol in replacement symbol area 232. In the example of FIG. 3, the replacement symbol is a “9” symbol. In one embodiment, the symbols placed in candidate symbol area 230 and replacement symbol area 232 are symbols displayed on simulated reels 202a-202e.

To win the game, the player must replace one of the symbols in the candidate symbol area 230 with the replacement symbol 232. If the replacement creates a winning pattern, such as a three-of-a-kind pattern, in candidate symbol area 230, the player wins the game. Thus, in the example of FIG. 3, if the player replaces the “A” candidate symbol with the “9” replacement symbol, the player wins the game. In some embodiments, other matches may also correspond to a winning pattern.

In one embodiment, the player may select the candidate symbol to be replaced by pressing his or her finger to the candidate symbol, if the game terminal 110 is equipped with a touch input device. In one embodiment, the player may use a keyboard or mouse to select the candidate symbol to be replaced.

Further, in one embodiment, an arrow or other visual indication may be displayed to direct the player's attention toward the candidate symbol area. The visual indication may instruct the player to select one of the candidate symbols to be replaced, and may bounce to and from each symbol in the candidate symbol area.

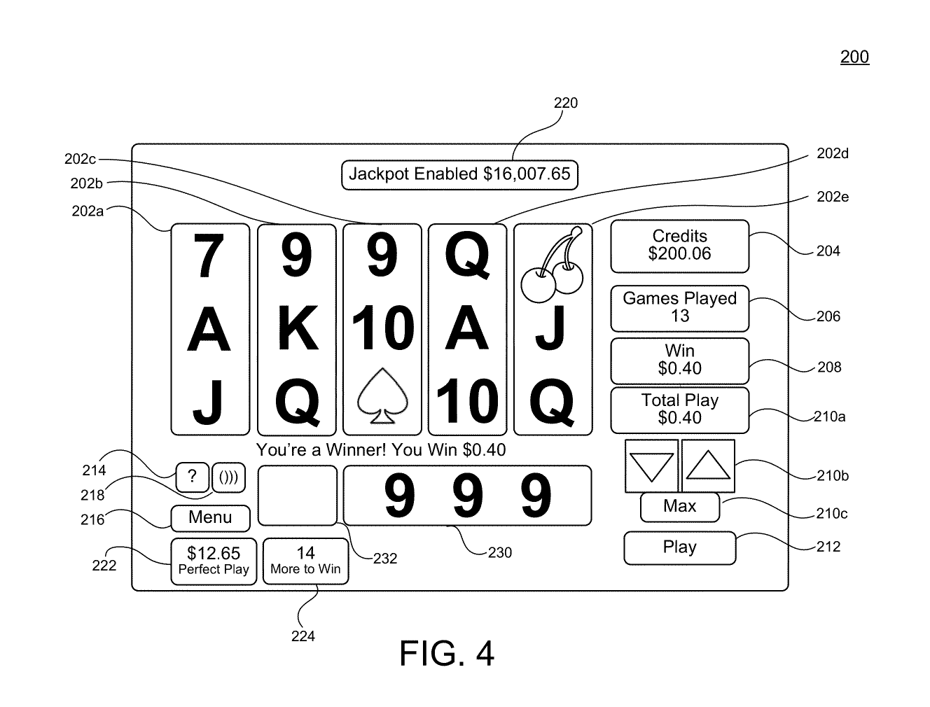

After the player selects the symbol to be replaced, game 200 may illustrate a win or loss. FIG. 4 is an example of a win, assuming the player replaces the “A” candidate symbol with the “9” replacement symbol, creating a “9” “9” “9” pattern. In the example of FIG. 4, the win may be indicated to the user by animating or coloring the candidate symbol area 230, and displaying a win line across the simulated reels 202a-202e. Other indications of a player win may be used as well. A win amount may be shown in area 208, and the player's available credits 204 may be increased by the win amount 208. The number of games played 206 may also be incremented after the player's win.

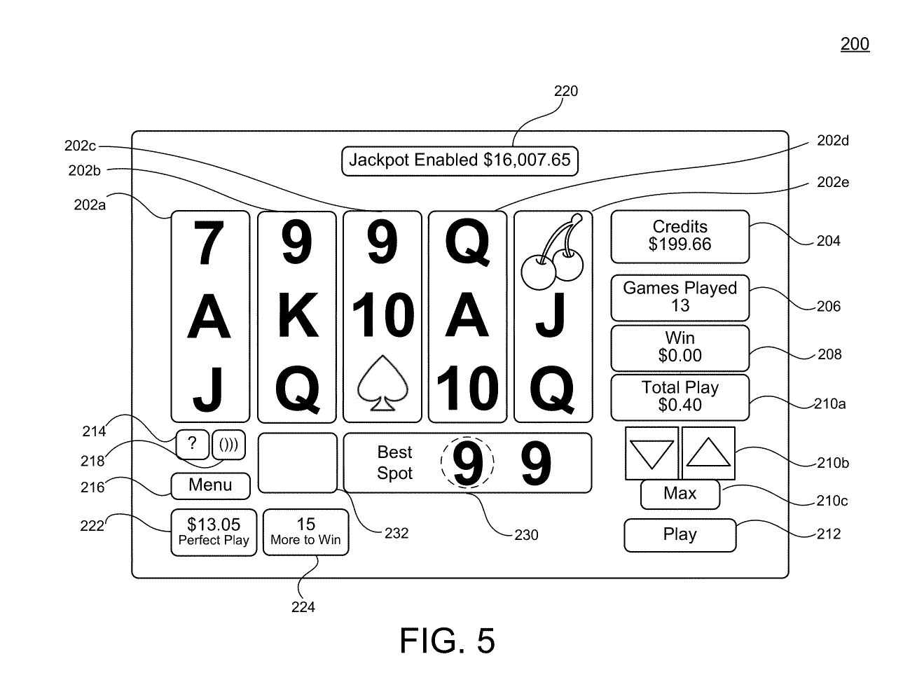

If the player selects a symbol in the candidate symbol area 230 to be replaced by the replacement symbol in replacement symbol area 232 that does not create a winning pattern, the player will lose the game. FIG. 5 is an example of a loss. In the example of FIG. 5, the player has selected to replace the “9” candidate symbol rather than the “A” candidate symbol (indicated by the dashed lines around the “9” symbol), creating an “A” “9” “9” pattern, which may not be a winning pattern. FIG. 5 displays the game 200 after the player has made the incorrect selection. In the example of FIG. 5, the game 200 may display an indication of which symbol should have been selected in order to win. Thus, for example, the game 200 may display a “BEST SPOT” icon in candidate symbol area 230 to indicate to the player that the player should have selected the symbol in that location to win the particular game. The number of games played 206 may also be incremented after the player's loss.

In one embodiment, any three-of-a-kind combination may be a winning combination. Winning combinations may be presented to the user on the main game screen, on a cabinet enclosing game terminal 110, or in a help or similar screen. For example, as seen in FIG. 2, the winning combinations may be displayed by selecting help button 214.

In some embodiments, a player may receive prizes in addition to, or replacement for, credits won in the game. In one such embodiment, a player may be provided with an opportunity to play a bonus round if he or she wins a particular game. In another such embodiment, a player may be provided with one or more free replays if he or she wins a particular game.

In one embodiment, a three-of-a-kind pattern or winning pattern may not be possible with the symbols displayed in candidate symbol area 230 and replacement symbol area 232. For example, if the symbols in candidate symbol area 230 are a “9” symbol, “A” symbol, and “Q” symbol, and the replacement symbol area 232 displays a “K” symbol, no three-of a-kind pattern is possible. The player may then play a subsequent game.

In one embodiment, the player may be rewarded for winning consecutive games, and may also be provided with an opportunity to win back money or credits that were lost as a result of a lost game. For example, as described above, bonus amount 222 may be increased by the amount played for each game a player loses. Thus, if a player incorrectly replaces a symbol, and used $0.30 to play that game, the bonus amount 222 may be increased by $0.30. Additionally, each time a player wins a game, the bonus counter 224 may be decremented. If the player wins a second consecutive game, the bonus counter 224 is further decremented. When the bonus counter reaches zero, the player may be rewarded with the bonus amount 222. If the player loses a game, however, the bonus counter 224 may be reset. In one embodiment, the bonus counter and bonus amount are not changed after any game which cannot be won. That is, if no candidate symbol can be replaced with the replacement symbol to create a winning pattern, the bonus counter is not decremented or reset, and the bonus amount is not increased.

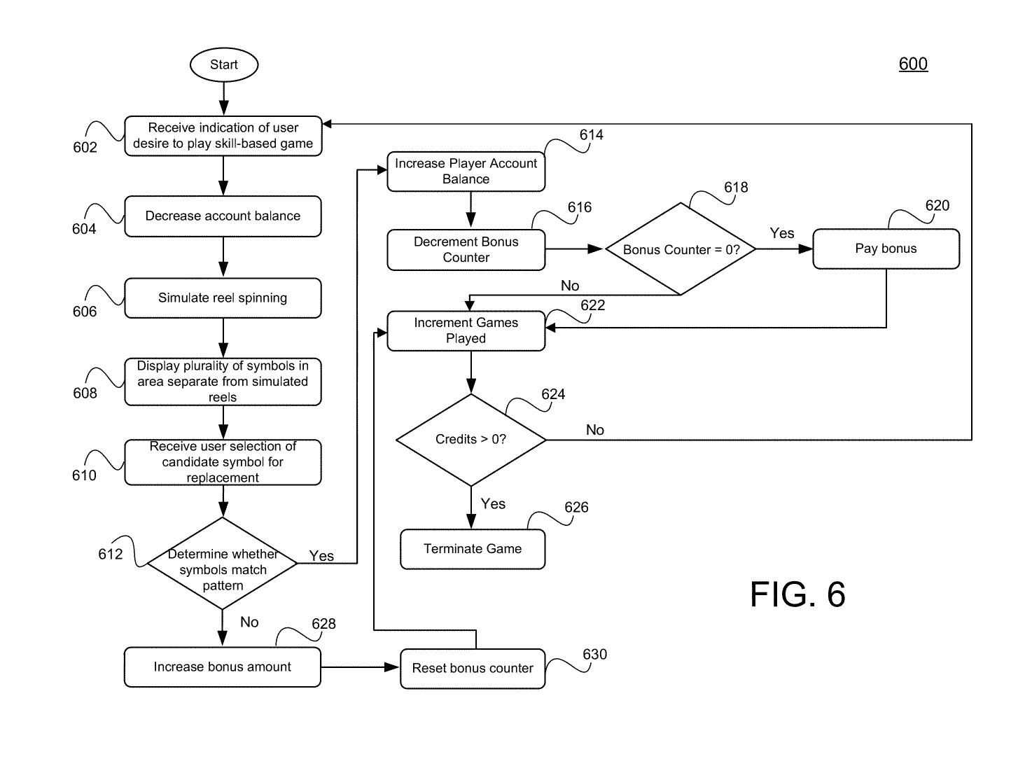

FIG. 6 illustrates a flow diagram of a method 600 for providing a skill-based redemption game to a user according to one or more embodiments of the present disclosure. Method 600 may be implemented, in one embodiment, by game module 118 of game terminal 110. Method 600 begins at block 602.

At block 602, an indication of a user's desire to participate in or play the skill-based redemption game is received. In one embodiment, the indication may be received as a result of a player pressing or otherwise selecting a “Play” button. In one embodiment, the player may choose a desired credit amount to use prior to indicating his or her desire to play the skill-based redemption game. In other embodiments, the credit amount is preselected. In one embodiment, the player must insert money or add credits to a payment device 126 before pressing the “Play” button.

At block 604, an account balance associated with the user or player may be decreased or debited. In one embodiment, the account balance is decreased according to the amount used by the player in that game. In one embodiment, the account balance may not be decreased if the player has received a bonus play or a free replay.

At block 606, a spin of the one or more simulated reels may be simulated, for example, by game module 118. For example, simulating a spin may include moving the symbols for a particular reel according to the symbols on the simulated reel, similar to a physical game reel.

At block 608, a plurality of symbols may be displayed in an area separate from the simulated reels. For example, in one embodiment, candidate symbols are displayed in the candidate symbol area 230, and a replacement symbol may be displayed in replacement symbol area 232. The symbols may be displayed after the spinning of the simulated reels terminates, or during the spinning of the simulated reels. The displayed symbols in the candidate symbol area 230 may or may not be related to the symbols displayed on the simulated reels 202a-202e. For example, the symbols in the candidate symbol area 230 may be symbols which are currently displayed on the simulated reels 202a-202e. In one embodiment, a visual indication may be provided to draw the player's attention to the candidate symbol area.

At block 610, a user selection of a candidate symbol for replacement by the replacement symbol is received. For example, the player may select a candidate symbol for replacement by pressing his or her finger on the candidate symbol, if the game terminal is equipped with a touch screen input device. Alternatively or additionally, the player may use an input device, such as a keyboard, mouse, or other input device, to select the candidate symbol for replacement.

At decision block 612, a determination is made as to whether the symbols in the candidate symbol area, after the player's replacement, match a winning pattern, such as a three-of-a-kind pattern. If the candidate symbols match a winning pattern, method 600 proceeds to block 614. If the candidate symbols do not match a winning pattern, method 600 proceeds to block 628.

At block 614, the player's account balance may be increased by a win amount corresponding to the winning pattern. In one embodiment, different winning combinations may be associated with different win amounts. Further, the player's account balanced may be increased based on patterns of symbols on the simulated reels, or according to one or more win lines across the symbols on the simulated reels. The win amount may be displayed on the game terminal, for example, in area 208.

At block 616, a bonus counter may be decremented by one. As described above, the bonus counter may be decremented each time the player wins a game. At decision block 618, a determination is made as to whether the bonus counter equals zero or meets another threshold. If so, method 600 proceeds to block 620, and the bonus may be paid to the player. Thus, for example, if the player has successfully won 15 games in a row, he or she may be eligible to receive the bonus amount, and the player's account balance may be increased by the bonus amount. After paying a bonus to the player, method 600 proceeds to block 622. If the bonus counter does not equal zero or does not meet a threshold at decision block 618, method 600 proceeds directly to block 622.

At block 622, a number of games played is incremented by one. Method 600 then proceeds to decision block 624, where a determination is made as to whether the account balance associated with the player is greater than zero. If the player's account balance is not greater than zero, method 600 may proceed to block 626, where the game is terminated, and the player may no longer play the game. If, at decision block 624, the player has sufficient credits in his or her account balance, method 600 returns to block 602.

As described above, if the candidate symbols do not match a winning pattern, method 600 proceeds to block 628. At block 628, a bonus amount may be increased by an amount used by the player. This may allow the player to recoup any lost money or credits, if he or she successfully wins the bonus amount at a later time. Method 600 then proceeds to block 630, where the bonus counter is reset to an initial value. Method 600 then proceeds to block 622, and method 600 continues as described above.

At any point in the operation of method 600, the player may terminate game play. For example, the player may select the menu button 216 , and choose an option in the menu, to terminate game play.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

Any software module incorporating the game software may contain a source program, executable program (i.e., object code), script, and/or any other entity comprising a set of instructions to be performed. In the case of a source program, the program may be translated via a compiler, assembler, interpreter, or the like, which may or may not be included within the memory, so as to operate properly in connection with the operating system. Furthermore, the game software can be written as an object oriented programming language, which has classes of data and methods, or a procedure programming language, which has routines, subroutines, and/or functions, for example but not limited to, C, C++, Pascal, Basic, Fortran, Cobol, Perl, Java, ASP, and Ada. In operation, a processor may be configured to execute software stored within memory, to communicate data to and from the memory, and to generally control operations of the game device as directed by the software. The game software and operating system, in whole or in part, may be read by the processor, may be buffered by the processor, and then executed.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for providing a skill-based game, comprising:
receiving, by at least one processor, an indication of a user desire to participate in the skill-based game;
decreasing, by the at least one processor, an account balance associated with the user;
simulating, by the at least one processor, a rotation of at least one displayed simulated reel comprising a first plurality of symbols;
displaying, by the at least one processor, a second plurality of symbols in one or more areas separate from the displayed at least one simulated reel, wherein the second plurality of symbols includes one or more replacement symbols and a plurality of candidate symbols;
receiving, by the at least one processor, a user selection of at least one of the plurality of candidate symbols in the second plurality of symbols to be replaced by at least one of the one or more replacement symbol;
updating, by the at least one processor, the second plurality of symbols to include the at least one user-selected replacement symbol;
determining, by the at least one processor and based on the user selection, that the second plurality of symbols matches a winning combination of symbols; and
increasing, by the at least one processor, the account balance associated with the user.

2. The computer-implemented method of claim 1 further comprising incrementing, by the at least one processor, a number of games played.

3. The computer-implemented method of claim 1, further comprising receiving, by the at least one processor and from the user, a desired number of credits, and wherein decreasing an account balance associated with the user further comprises decreasing the desired number of credits from the account balance associated with the user.

4. The computer-implemented method of claim 1, further comprising terminating the skill-based game when the account balance associated with the user equals zero.

5. The computer-implemented method of claim 1, wherein the second plurality of symbols includes one or more symbols in the first plurality of symbols.

6. The computer-implemented method of claim 1, wherein the first plurality of symbols and the second plurality of symbols contain an odd number of symbols.

7. The computer-implemented method of claim 1, further comprising:
receiving, by the at least one processor and over a network, the account balance associated with the user; and
transmitting, by the at least one processor and over the network, the increased account balance associated with the user.

8. The computer-implemented method of claim 1, further comprising:
receiving, by the at least one processor and over a network, an updated game module.

9. The computer-implemented method of claim 1, further comprising:
decrementing, by the at least one processor, a bonus counter when the second plurality of symbols matches a stored winning combination of symbols; and
increasing, by the at least one processor, the account balance associated with the user when the bonus counter is equal to zero.

10. A game device, comprising:
a display;
an input device;
at least one processor; and
at least one memory storing:
one or more winning combinations of symbols, and
computer-executable instructions that, when executed by the at least one processor, cause the at least one processor to:
receive an indication of a user desire to participate in a skill-based game;
decrease an account balance associated with the user;
simulate a rotation of at least one displayed simulated reel comprising a first plurality of symbols;
display a second plurality of symbols in one or more areas separate from the at least one displayed simulated reel, wherein the second plurality of symbols includes one or more replacement symbols and a plurality of candidate symbols;
receive a user selection of at least one of the plurality of candidate symbols in the second plurality of symbols to be replaced by at least one of the one or more replacement symbols;
update the second plurality of symbols to include the at least one user-selected replacement symbol;
determine, based on the user selection, that the second plurality of symbols matches a stored winning combination of symbols;
increase the account balance associated with the user; and
increment a number of games played.

11. The game device of claim 10, the memory further storing computer-executable instructions that, when executed by the at least one processor, cause the at least one processor to receive, from the user, a desired number of credits, and wherein decreasing an account balance associated with the user further includes decreasing the desired number of credits from the account balance associated with the user.

12. The game device of claim 10, the memory further storing computer-executable instructions that, when executed by the at least one processor, cause the at least one processor to terminate the skill-based game when the account balance associated with the user equals zero.

13. The game device of claim 10, wherein the second plurality of symbols includes one or more symbols in the first plurality of symbols.

14. The game device of claim 10, wherein the first plurality of symbols and the second plurality of symbols contain an odd number of symbols.

15. The game device of claim 10, the memory further storing computer-executable instructions that, when executed by the at least one processor, cause the at least one processor to:
receive, over a network, the account balance associated with the user; and
transmit, over the network, the increased account balance associated with the user.

16. The game device of claim 10, the memory further storing computer-executable instructions that, when executed by the at least one processor, cause the at least one processor to receive, over a network, an updated game module.

17. The game device of claim 10, the memory further storing computer-executable instructions that, when executed by the at least one processor, cause the at least one processor to:
decrement a bonus counter when the second plurality of symbols matches a stored winning combination of symbols; and
increase the account balance associated with the user when the bonus counter is equal to zero.

18. A non-transitory computer-readable medium comprising instructions, that when executed by at least one processor, cause the at least one processor to:
receive an indication of a user desire to participate in a skill-based game;
decrease an account balance associated with the user;
simulate a rotation of at least one displayed simulated reel comprising a first plurality of symbols;
display a second plurality of symbols in an area separate from the at least one displayed simulated reel, wherein the second plurality of symbols includes one or more replacement symbols and a plurality of candidate symbols;
receive a user selection of at least one of the plurality of candidate symbols in the second plurality of symbols to be replaced by at least one of the one or more replacement symbols;
determine, based on the user selection, if the second plurality of symbols matches a stored winning combination of symbols;
increase the account balance associated with the user when the second plurality of symbols matches a stored winning combination of symbols; and
increment a number of games played.

19. The computer-readable medium of claim 18, the medium comprising further instructions that, when executed by at least one processor, cause the at least one processor to receive, from the user, a desired number of credits, and wherein decreasing an account balance associated with the user further includes decreasing the desired number of credits from the account balance associated with the user.

20. The computer-readable medium of claim 18, the medium comprising further instructions that, when executed by at least one processor, cause the at least one processor to:
receive, over a network, the account balance associated with the user; and
transmit, over the network, the increased account balance associated with the user.

21. The computer-readable medium of claim 18, the medium comprising further instructions that, when executed by at least one processor, cause the at least one processor to:
decrement a bonus counter when the second plurality of symbols matches a stored winning combination of symbols; and
increase the account balance associated with the user when the bonus counter is equal to zero.

22. A computer-implemented method for providing a skill-based game, comprising: displaying, by at least one processor,
a simulated reel comprising a first plurality of symbols and
a second plurality of symbols in one or more areas separate from the displayed at least one simulated reel, wherein the second plurality of symbols includes one or more symbols in the first plurality of symbols;
decrementing, by at least one processor, a bonus counter when the second plurality of symbols matches a stored winning combination of symbols; and
increasing, by the at least one processor, an account balance associated with a user when the bonus counter is equal to zero.
